(19) United States
(12) Patent Application Publication
(10) Pub. No.: US 2026/0073805 A1
(43) Pub. Date: Mar. 12, 2026

(54) FILL-IN-THE-BLANK QUESTION GENERATION SYSTEM ALIGNED WITH EDUCATIONAL CURRICULUM FOR A USER USING INTEGRATED PROGRAMMATIC CONTROL AND SPECIALIZED GUIDED AND CONSTRAINED ARTIFICIAL INTELLIGENCE

(71) Applicant: 2hr Learning, Inc., Austin, TX (US)

(72) Inventors: Niraj Patel, London (GB); Janet Demir, Ortaca (TR); Sean Carlson, Austin, TX (US); Nima Shirazian, Austin, TX (US)

(73) Assignee: 2hr Learning, Inc., Austin, TX (US)

(21) Appl. No.: 19/273,077

(22) Filed: Jul. 17, 2025

Related U.S. Application Data
(60) Provisional application No. 63/672,416, filed on Jul. 17, 2024.

(51) Int. Cl. G09B 7/02; G06Q 50/20

(52) U.S. Cl. CPC G09B 7/02; G06Q 50/205

(57) ABSTRACT

A fill-in-the-blank generation system and method integrates programmatic control and a guided and constrained AI engine to generate a fill-in-the-blank (FITB) question aligned with the educational curriculum of the user. The study mode delivery system accesses the data from the educational standards database and historical database. The study mode delivery system receives a standard description and set of key terms from the data accessed from the databases. The analyzer integrated within the study mode delivery system analyzes the course, standard description, and key terms relevant to the educational curriculum and standards.

### CROSS-REFERENCE TO RELATED APPLICATION(S)

This application claims the benefit under 35 U.S.C. § 119(e) and 37 C.F.R. § 1.78 of U.S. Provisional Application No. 63/672,416, which is incorporated by reference in its entirety.

### FIELD OF THE INVENTION

The present invention relates in general to the field of electronics, and more specifically to generate precise specific fill-in-the-blank questions along with detailed contextual clues within the question to enable a user to identify the correct answer in an online learning platform.

### BACKGROUND

Educational assessment evaluates a learner's progress and knowledge in an online learning platform. The evaluation can be in the form of a test, quiz, project, or assignment. The test may include questions in the form of MCQs, fill-in-the-blanks, true-false, and so on. Educational assessments often use generic questions that test general understanding without focusing on specific learning objectives. The questions ask for a general description of a concept without requiring the application of the concept in a specific context leading to superficial learning and assessment.

The conventional technology in educational assessment often involves the creation of open-ended questions that may not precisely assess the student's understanding of specific details within a standard. The open-ended questions encourage students to answer in a detailed way based on their knowledge. The answers are in the form of lists, sentences, or speech. However, the questions require more time to answer and grade and the response of the students can be highly variable which makes the standardization difficult.

The multiple-choice question is an assessment item consisting of a stem that poses the question or problem followed by a list of possible responses that assess the students based on the option marked by the student. However, the MCQs require guessing correct answers which may reduce the precision in the assessment of a student's true understanding. The students answer a correct option by guessing without even the knowledge of the material thus leading to inefficiencies in assessment.

### SUMMARY

In at least one embodiment, a method integrates programmatic control and a guided and constrained Artificial Intelligence (AI) engine to generate fill-in-the-blank (FITB) questions aligned with an educational curriculum for a user. The method includes executing code using one or more processors of a computer system to cause the computer system to perform operations. The operations include accessing an educational standards database and a historical database by a study mode delivery system to retrieve relevant educational content. The operations include receiving a standard description and a set of key terms from the relevant educational content from a user profile, educational standards, and historical database accessed by the study mode delivery system. The operations include utilizing a natural language processing (NLP) model by an analyzer to analyze the received educational content. The operations include generating a prompt by a prompt generator to guide the AI engine to generate an initial FITB question, including a corresponding answer and learning content based on the standard description and the set of key terms. The operations include transferring the prompt to the AI engine to generate the FITB question, along with the corresponding answer and learning content. The operations include guiding and constraining the AI engine using an engineered prompt to refine the initially generated FITB question to generate the final FITB question, along with the corresponding answer and learning content, by aligning with the educational standard and learning content.

In at least one embodiment, a system integrates programmatic control and a guided and constrained Artificial Intelligence (AI) engine to generate fill-in-the-blank (FITB) questions aligned with an educational curriculum for a user. The system includes one or more processors of a computer system and a memory, coupled to the one or more processors, storing code that, when executed, causes the computer system to perform operations. The operations include accessing an educational standards database and a historical database by a study mode delivery system to retrieve relevant educational content. The operations include receiving a standard description and a set of key terms from the relevant educational content from a user profile accessed by the study mode delivery system. The operations include utilizing a natural language processing (NLP) model by an analyzer to analyze the received educational content. The operations include generating a prompt by a prompt generator to guide the AI engine to generate an initial FITB question, including a corresponding answer and learning content based on the standard description and the set of key terms. The operations include transferring the prompt to the AI engine to generate the FITB question, along with the corresponding answer and learning content. The operations include guiding and constraining the AI engine using an engineered prompt to refine the initially generated FITB question to generate the final FITB question, along with the corresponding answer and learning content, by aligning with the educational standard and learning content.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary fill-in-the-blank (FITB) generation environment to generate FITB questions based on educational standards and key terms.

FIG. 2 depicts an exemplary fill-in-the-blank (FITB) generation process for generation of FITB questions based on educational standards and key terms.

FIG. 3 depicts a flowchart showing the steps to generate the FITB question.

FIG. 4 represents a data structure storing information used to craft a FITB question based on educational standards and key terms of the relevant educational curriculum.

FIG. 5 depicts an exemplary user interface disclosing the AI-generated FITB question and learning content presented to the user on the study mode of the online learning platform.

FIG. 6 depicts an exemplary user interface disclosing the user's attempt to answer a FITB question presented on the study mode of the online learning platform 102.

FIGS. 7-9 depict exemplary user interfaces displaying the incorrect response of the user and interaction with the AI-generated learning content.

FIG. 10 depicts an exemplary user interface if the user attempts the question correctly and interacts with the learning content.

FIG. 11 depicts an exemplary user interface accessing information from the educational standards database.

FIG. 12 depicts an exemplary network environment in which the system of FIG. 1 and the process of FIG. 2 may be practiced.

FIG. 13 depicts an exemplary computer system.

### DETAILED DESCRIPTION

A fill-in-the-blank generation system and method integrates programmatic control and a guided and constrained AI engine to generate a fill-in-the-blank (FITB) question aligned with the educational curriculum of the user. The study mode delivery system accesses the data from the educational standards database and historical database. The study mode delivery system receives a standard description and set of key terms from the data accessed from the databases. The analyzer integrated within the study mode delivery system analyzes the course, standard description, and key terms relevant to the educational curriculum and standards.

In at least one embodiment, the AI engine utilizes at least two prompts to generate a FITB question, answer, and the learning content. The core prompt guides the AI engine to generate the FITB question, answer, and the learning content. The second prompt which is a refinement prompt refines the generated FITB question, answer, and learning content and displays it to the user in the study mode of the online learning platform.

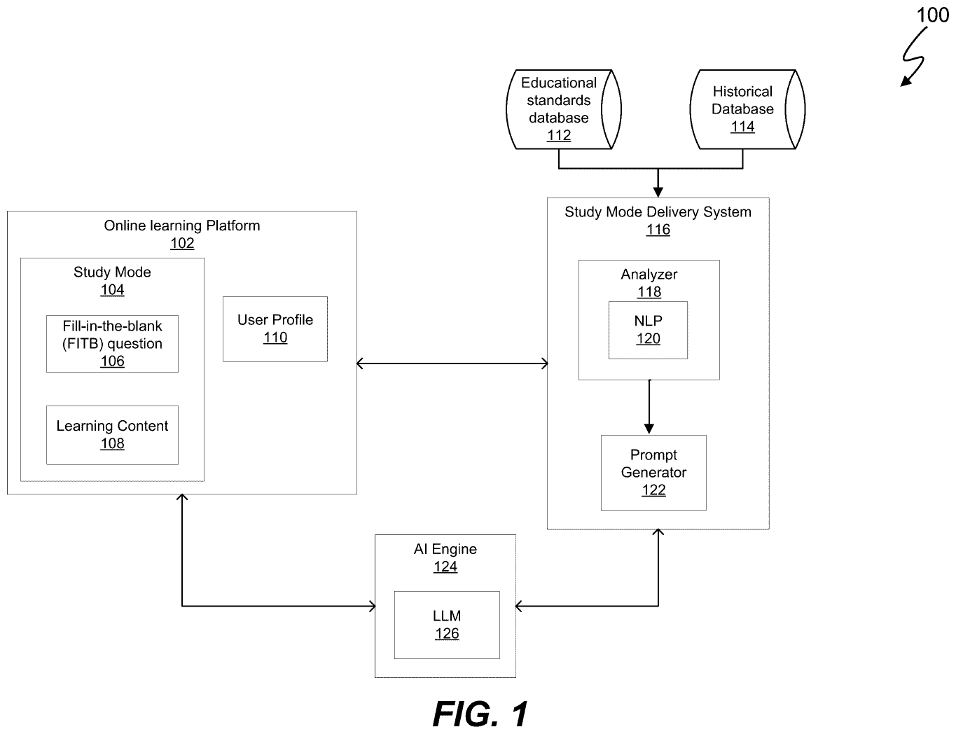

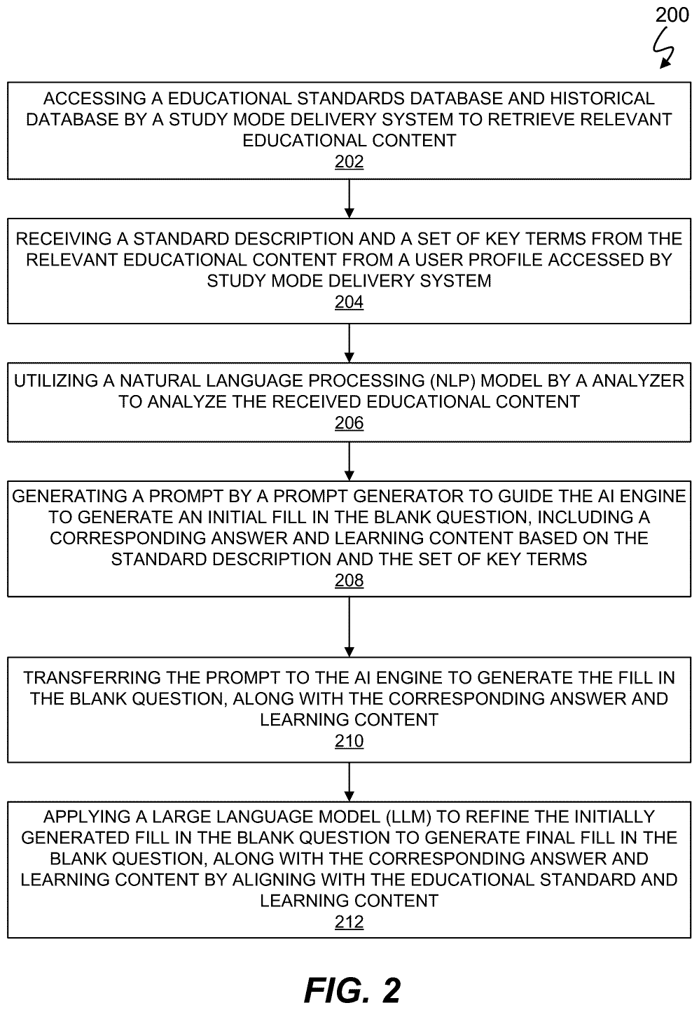

FIG. 1 depicts an exemplary fill-in-the-blank (FITB) generation environment 100 for generating FITB questions 106 and learning content 108 aligned with the educational standards of the user. FIG. 2 depicts an exemplary FITB generation process 200 utilized by the FITB generation system.

Referring to FIGS. 1 and 2, in operation 202, a study mode delivery system 116 accesses an educational standards database 112 and a historical database 114 to retrieve relevant educational content. The study mode delivery system 116 accesses the educational standards database 112 and the historical database 114. The study mode delivery system 116 is operatively coupled to an online learning platform 102. The study mode delivery system 116 fetches the details from the educational database 112 and the historical database 116. The study mode delivery system 116 delivers content to the user aligned with the user's education standards.

The educational standards database 112 includes details of the educational curriculum related to the educational standards. The educational standards include details of the content of a particular grade or class. The education standards are designed by the educational authorities and the learning content is aligned with the user's grade or class such that the user gains the knowledge and skills required at each grade. The educational curriculum includes details of different courses. Each course within the educational standard database is further divided into topics where topics are bifurcated into standards and sub-standards. Each standard and sub-standard explains the concept of the topics of the particular course. The testing agencies publish the data, including a list of courses and the standards. In one of the embodiments, the educational standards can be accessed from Common Core State Standards (CCSS), Next Generation Science Standards (NGSS), and Advanced Placement (AP).

The study mode delivery system 116 accesses the educational standards database 112 to access information on the courses along with their relevant standard IDs and standard descriptions. The educational standard database 112 details the key terms relevant to each standard. In one of the embodiments, a data collector is integrated within the study mode delivery system 116 to access the details from the databases.

The key terms refer to specific concepts, vocabulary, and terminologies to understand the concept within each course. The key terms are bifurcated based on the description of standards which includes events, people, places, objects, processes and systems, concepts and theories, and document policies and laws. The incorporation of key terms helps to contextualize the learning and make it relatable to the user. For instance, the incorporation of a key event, or key concept in the question helps the user to understand the question and makes it easier for the user to remember a particular concept and answer the question. For example, in a science curriculum, key terms 102 include concepts such as “photosynthesis,” “gravity,” and “molecular structure.” In a mathematics curriculum, key terms 102 include “algebra,” “geometry,” and “probability.”

Furthermore, the study mode delivery 116 system accesses the historical database 114 to access information on historical figures relevant to a course and education standard. The details of the historical figures contain information about the name of the historical figures, their audio image, and bio to create a realistic tutor to provide engaging content to the user. In one of the embodiments, a foreign key is used to retrieve the corresponding standard description and relevant standard IDs.

In operation 204, the study mode delivery system 116 receives a standard description and set of key terms from the relevant educational content from a user profile 110.

The study mode delivery system 116 receives the relevant standard description and key terms from the data accessed using the educational standards database 112 and the historical database 114. The study mode delivery system 116 accesses data from a user profile 110. The user profile 110 is integrated into the online learning platform 102 and contains details of the course the user is studying in study mode 104 of the online learning platform 102. The study mode delivery system 116 presents content related to the subject the user is studying and contains interactive elements to enhance the learning gained by the user. The study mode delivery system 116 receives the details of the course a user is studying in the study mode 104 of an online learning platform 102 and aligns with the details of the educational standards, key terms, and historical figures such that the study mode delivery system 116 has enough dataset to generate assessment questions. In one of the embodiments, a receiver integrated within the study mode delivery system 116 can collect the details of the relevant educational content to generate assessment questions.

In operation 206, an analyzer 118 analyzes the received educational content by utilizing the Natural Language Processing (NLP) 120 algorithm. The NLP 120 algorithm analyzes and structures the education content into an assessment question. The analyzer 118 analyzes the educational standards and identifies the key terms for which a fill-in-the-blank (FITB) question 106 will be generated.

The analyzer 118 is integrated within the study mode delivery system 116 and utilizes the NLP 120 algorithm to analyze the received educational content and structure the educational content into a question format. The analyzer 118 analyzes and extracts key terms relevant to the education standard to structure the education content into the assessment question. The analyzer 118 analyzes the key terms relevant to the standards from the data received by the study mode delivery system 116. The NLP 120 extracts a unique set of identifiers around which the question will be generated without giving the contextual clues of the answer.

The assessment questions are fill-in-the-blank (FITB) questions 106 which assess the user's understanding of the key concept of a particular standard. The FITB questions 106 are highly specific and contain enough information about a concept for the user to answer. For instance, assessment questions are prepared for biology, and analyzer 118 will utilize the NLP 120 algorithm to analyze the key concepts related to photosynthesis. The analyzer 118 analyzes and extracts the key terms related to chlorophyll belonging to grade 13. The key terms include key term objects such as “chloroplast”, chlorophyll a and b, and so forth, key term concepts describing photosynthesis such as “endosymbiotic theory”, key processes related to photosynthesis such as “Calvin Cycle”, and “light-dependent reactions”. The key terms are crucial to explain the concept of photosynthesis and provide contextual clues for the concept of photosynthesis.

In addition, analyzer 118 also extracts the relevant historical figures along with their audio, and images to pass this information to the prompt generator for the generation of learning content 108. For instance, if content is related to DNA, the image, and audio of “Francis Crick” is used.

In operation 208, a prompt generator 122 guides an AI engine 124 to generate an initial fill-in-the-blank (FITB) question 106, including a corresponding answer and learning content based on the standard description and the set of key terms.

Before prompt generation, a prompt engineer generates a prompt structure along with the rules and guidelines to generate the prompt. These rules and guidelines along with the prompt structure are sent to the prompt generator 122 which fetches the analyzed data and populates the prompt structure.

The prompt generator 122 is operatively coupled to the study mode delivery system 116 and generates the prompts based on the inputs received from the analyzer 118. The prompt generator 136 is then used to populate a prompt structure that guides the AI engine 124 to generate highly specific FITB questions 106 and learning content 108 which is then displayed on the online learning platform 102. The prompt generator 122 utilizes the insights provided by the analyzer 118 along with the prompt structure provided by the prompt engineer, which also contains a set of rules and guidelines for writing a prompt.

The prompt generator 122 utilizes two prompts to generate a highly specific FITB question 106, and its answer and learning content. A core prompt guides the AI engine 124 to generate an initial FITB question 106 along with the learning content 108.

The FITB questions 106 are uniquely designed to ensure the answer is unambiguously identified through the context provided within the question itself. The FITB question 106 includes a blank space. The FITB questions 106 are highly specific to the education content. The FITB question 106 helps in assessing a student's understanding of key concepts within the educational standards.

The core prompt utilizes the key terms extracted by the analyzer 118 to generate a FITB question 106, along with the answer and learning content 108. The core prompt also utilizes the information of historical figures to generate an appropriate learning content 108.

An exemplary prompt constrains and guides the AI Engine 124 as follows:

```
Context
--------
You are a Fill-in-the-Blank (FITB) Question generator. You generate
unambiguous yet educationally challenging FITB questions for students. The
FITB Question should be a granular statement of fact about the educational
Standard. The Answer must be a SINGULAR piece of vocabulary specific to the
Course. Don't use the Key Term as the Answer, but you should use it as extra
inspiration, drawing on it for examples or context when generating the FITB
question.
Examples
--------
Example 1:
{
  ″question″: ″The cultivation of tobacco was a pivotal development in the
Chesapeake and North Carolina colonies, initially relying on labor from
primarily white <blank> servants.″,
  ″answer″: ″indentured″,
  ″learning_content″: “In examining the transformation of the British
colonies, one must consider the roles played by various agricultural
products. Tobacco, popularized in the colonies by the key contributions of
John Rolfe, became the centerpiece of the Chesapeake and North Carolina
colonies' economies. This cash crop demanded extensive labor, initially
provided by white indentured servants. However, as the demand grew, so did
the shift towards employing enslaved Africans, a practice with deep and
lasting consequences for both the economy and the society of these colonies.″
}
Example 2:
{
  ″question″: ″Plants use signal chemicals called <blank> to ward off
herbivores and attract pollinators, enhancing their survival through
interaction with other organisms.″,
  ″answer″: ″pheromones″,
  ″learning_content″: ″Plants use an array of strategies to enhance their
survival in changing environments. One such strategy is employing pheromones,
or chemical signals, to manipulate the behavior of other organisms. For
example, they emit certain pheromones to deter herbivores, whereas others
attract pollinators, ensuring their reproductive success. Through these
physiological mechanisms, plants actively influence and respond to their
ambient environment, and interact with other organisms.″
}
Task
--------
1. Identify an extremely important piece of vocabulary central to an
understanding of the Standard, drawing upon inspiration from the Key Term.
This vocabulary should be the objective name of an important person, process,
event, object, or academic concept, which students of the Course MUST
memorize. Extract the identifying, non-root words from this term and use
these as the Answer. Answers should be one word whenever possible.
2. Craft an eloquent sentence containing the Answer. The sentence should
contain highly detailed and uniquely identifying information about the
Answer. Don't just repeat the Standard-be creative! Use this sentence as the
Question. Replace the Answer in the Question with ‘<blank>’, making the
Question a Fill-in-the-Blank.
3. Craft a short lecture explaining everything about the Standard that a
student of the Course would need to know to answer the Question. Output this
lecture as the Learning Content.
Output Template
--------
- Question: An extremely specific statement related to the Standard. The
Question statement must be as specific as possible to the Answer, including
specific details about the correct Answer. The Answer should be denoted by a
′<blank>′.
- Answer: Most importantly, the Answer must either be a proper noun or a
definitive Standard-specific term. The Answer should be the only word that
could possibly fill the ‘<blank>’.
- Learning Content: The Learning Content should be very detailed, and its
primary purpose is to teach the student about the Standard.
Rules
--------
Question rules:
- The tense and part-of-speech of the ′<blank>′ (the Answer) MUST be made
blatantly obvious by the Question.
Answer rules:
- The Answer MUST be one word.
- The Answer MUST be a flashcard term that is commonly studied by ALL
students of the Course.
- The Answer MUST NEVER contain root terms like ′movement,′ ′act′, ′law′,
‘system’, etc. Root terms should be included in the Question instead. For
example, ′Fugitive Slave Act′ is a TERRIBLE Answer. ′Fugitive Slave′ is a
GREAT Answer. The word ′act′ should appear in the Question.
- The Answer MUST NEVER include a proper noun UNLESS the Answer is a
historical figure or a term named after a historical figure.
- The Answer MUST NOT be exactly the same as a given Key Term.
- The Answer MUST NEVER be a number or mathematical symbol.
Learning Content rules:
- The Learning Content should provide educational information rich in content
without filler.
- The Learning Content should teach the student specific information related
to the Standard and the ‘<blank>’ (Answer).
- The Learning Content must not repeat the information from the Question and
not mention the Standard.
- The Learning Content should go beyond the Question and focus on providing
additional interesting context.
- If the Learning Content gives away the Answer, the Answer should be
contained in the second half of the Learning Content.
- The Learning Content MUST NEVER mention the names of ANY of the Core Input
fields.
Word Count and Length Rules:
- Question Length: The Question statement length must be under 20 words, 1 -
2 sentences.
- Learning Content Length: The Learning Content must be 60-80 words, 3 - 5
sentences.
Core Inputs
--------
Course: {{ course }}
Standard: {{ standardDescription }}
Key Term: {{ standardAttribute ‘KeyTerm’ }}
```

### Prompt Explanation:

The study mode delivery system 116 receives input from the educational standards database 112, and the historical database 114. The analyzer 118 analyzes the data using NLP 120 and extracts the relevant key terms for which FITB questions 106 are developed. The prompt guides the AI engine 124 to generate an educationally challenging FITB question 106 for the user. The prompt generator 122 provides the relevant course, educational standards, and key terms inputted by the prompt engineer to the AI engine 124. The prompt engineer sets different rules including the length of the questions, answers, and learning content 108 displayed to the user on the study mode 104 of the online learning platform 102. The key terms used to generate a FITB question 106 cannot be used as the answer and the sentence should contain enough context to generate a FITB question 106.

In operation 210, the prompt generator 122 transfers the prompt to an AI engine 124 to generate the FITB question 106 along with the corresponding answer and the learning content 108.

The AI engine 124 is coupled to the study mode delivery system 116 and the online learning platform 102. The core prompts provided by the prompt engineer to the prompt generator 122 are transferred to the AI engine 124 to generate the FITB question 106, its answer, and the learning content 108 related to the FITB question 106.

The AI engine 124 utilizes the LLM 126 to generate the FITB question 106, answer, and learning content 108. The LLM 126 in this case is GPT-4 which inputs the core prompts provided by the prompt engineer to generate study content for the user. In one of the embodiments “gpt-4-0613” is utilized to generate the output question. A request to openAI API includes function calling to develop the FITB question 106, answer, and learning content 108 from the core prompts.

The AI engine 124 implements the prompt transferred by the prompt generator 122. The AI engine 124 utilizes the function calling which generates an output in a structured manner. The AI engine 124 sends a POST request to an LLM, such as OpenAI's GPT 4, completions application program interface (API) used to generate a FITB question 106. Note, the large language model (LLM 126) selection is a matter of design choice, and the type of model is also a design choice, such as specialized language model.

```
curl -X POST “https://api.openai.com/v1/chat/completions” \
-H “Authorization: Bearer {<INSERT OPENAI_API_KEY HERE>}” \
-H “Content-Type: application/json” \
-d ‘{
  “model”: “gpt-4-0613”,
  “messages”: [{“role”: “user”, “content”: “<INSERT CORE PROMPT HERE>”}],
  “temperature”: 1,
  “tools”:[
    {
  “type”:“function”,
  “function”:{
    “name”:“get_FITB_question”,
    “description”:“Get a Fill-in-the-Blank Question for an educational
Standard”,
    “parameters”:{
      “type”:“object”,
      “properties”: {
        “question”: {
          “type”: “string”,
          “description”:“The Question”
        },
        “answer”: {
          “type”: “string”,
          “description”:“The Answer to the Question”
        },
        “learning_content”: {
          “type”: “string”,
          “description”:“Learning Content Dialogue”
        }
      },
      “required”: [
        “question”,
        “answer”,
        “learning_content”
      ]
    }
  }
}
  ],
  “tool_choice”: {
    “type”: “function”,
    “function”: {“name”: “get_FITB_question”}
  }
}
```

### Explanation:

The prompt generator 122 generates a prompt with examples to increase the quality of the output. The examples include the description. The following exemplary prompt constrains and guides the AI Engine 124 to generate a FITB question 106, its answer, and learning content 108:

```
{
  ″question″: ″Certain proteins called <blank> enhance an organism's
survival by identifying and neutralizing harmful substances
such as microbes
and toxins in its environment.″,
  ″answer″: ″antibodies″,
  ″learning_content″: ″When exploring genetic variations, one important
factor is how these variations can enhance an organism's probability of
survival and reproduction in a specific environment.
For example, variations
can lead to the production of different proteins such as antibodies.
Antibodies play a critical role in the immune response by specifically
recognizing and binding to harmful substances, like bacteria, viruses, or
toxins, thus neutralizing their harmful effects. The presence of successful
antibodies can drastically increase an organism's survival
chance and ability
to reproduce.″
}
```

In operation 210, the AI engine 124 refines the initially generated FITB question 106 to generate a final FTIB question 106 along with the final answer and the learning content 108 by aligning with the educational standard and learning content using LLM 126.

As the AI engine 124 generates an initial FITB question 106, answer, and learning content, a second prompt guides the AI engine 124 to refine the generated content. The refinement prompt makes sure that there is enough context within the surrounding part of the question to be of high quality.

An exemplary prompt constrains and guides the AI Engine 124 with a refinement prompt given below:

Context
--------
You are a highly astute and notoriously nit-picky educator. You will be given
a Fill-in-the-Blank Question, which contains a ‘<blank>’, as well as the
Answer which is intended to uniquely fill the ‘<blank>’. Your job is to
revise the provided Question to ensure that ONLY THE PROVIDED ANSWER can fill
the ‘<blank>’. Do this by including additional details in the Question
sentence, which a well-educated student will be able to use to unambiguously
identify the Answer. Append additional terms to the Alternate Answers to
ensure all academically valid synonyms and rewordings of the Answer are
accounted for.
Examples
--------
Example 1:
Input Question: The surge in demand for political news and diverse media
outlets has sparked discussions over the influence of a <blank>, both in
terms of bias in news presentation and its overall effect on political
institutions and behavior.
Input Answer: media ownership
Output Question: The surge in demand for political news and diverse media
outlets has sparked discussions over the influence of <blank> ownership,
questioning the ways in which corporate influence might bias news
presentation.
Output Answer: media
Alternate Answers: [“press”, “mass media”, “news”]
Explanation: In this case, the original Question does not uniquely implicate
‘media ownership.’ The revised Question is superior, because it includes an
explicit reference to corporate influences on news media, thus uniquely
identifying ‘media ownership’ as the completion of the Question. Vitally, the
revised Question also removes an awkward article, ensuring the Question and
Answer obey key grammatical conventions. The Alternate Answers make the
overall Question even better by accounting for synonyms and rewordings of the
Answer.
Example 2:
Input Question: The <blank> was instrumental in carrying out diplomatic
initiatives to handle the continued British and Spanish presence in North
America as U.S. settlers migrated beyond the Appalachians.
Input Answer: Democratic-Republican Party
Output Question: Under the leadership of Thomas Jefferson and James Madison,
the <blank> was a key political party, instrumental in carrying out
diplomatic initiatives to handle the continued British and Spanish presence
in North America.
Output Answer: Democratic-Republican Party
Alternate Answers: [“Democratic-Republicans”, “Jeffersonian Republican
Party”, “Jeffersonian Republicans”]
Explanation: In this case, the original Question does not uniquely implicate
‘Democratic-Republican Party′. The revised Question is superior because it
identifies the ′<blank>′ as a political party, and identifies its founders.
Vitally, these additional clues disambiguate the answer ONLY to knowledgeable
students with masterful understandings of the Answer. The Alternate Answers
make the overall Question even better by accounting for all synonyms and
rewordings of the Answer.
Task
--------
1. Revise the Question: the Question MUST be altered, adding an additional
clause that strongly connects the Answer to the phrasing of the Question.
2. Compile a list of all academically-recognized synonyms, rewordings,
shorthands, long-forms, or abbreviations of the Answer that could correctly
complete the Question sentence. Output these as Alternate Answers.
Output Template
--------
- Revised Question: A revised version of the inputted Question. Revisions
must focus on tailoring the question specifically to the Answer, providing
relevant elaboration where necessary to ensure a strong and obvious mapping
between the Question and Answer. The Answer should be denoted by a ′<blank>′.
- Revised Answer: The exact same Answer as was inputted. The ONLY times an
Answer output should differ from the inputted answer is to remove punctuation
from the Answer or change the plurality of the Answer.
- Alternate Answers: Alternate answers to the Fill-in-the-Blank question.
These should mirror the original answer's structure perfectly and seamlessly
fill the ‘<blank>’ without causing grammatical errors.
Rules
--------
Question rules:
- Do not change the overall length of the Question by more than 5 words.
Answer rules:
- Alternate Answers MUST ALL fit into the question grammatically perfectly.
Make sure, for example, that alternate answers DO NOT start with “the” if the
‘<blank>’ is preceded by the word “the”.
- The Answer and Alternate Answers MUST NEVER contain root terms like
′movement,′ ′act′, ′law′, ‘system’, etc. Root terms should be included in the
Question instead. For example, ′Fugitive Slave Act′ is a TERRIBLE Answer.
′Fugitive Slave′ is a GREAT Answer. The word ′act′ should appear in the
Question.
- Alternate Answers MUST ALL be the exact same number of words and part of
speech as the Answer.
- Alternate Answers MUST NOT use synonyms for names of people, documents,
places, laws, or events. For example, if the Answer were “Stamp Act”, an
Alternate Answer MUST NOT be “Letter Act”.
- If it is unclear whether the Answer should be singular or plural, ensure
both forms are included as part of the Answer or Alternate Answers.
- Alternate Answers should include all obvious rewordings of the Answer. For
example, if the Answer is “tenements”, the Alternate Answers MUST include
“tenement housing.”
- Ensure that Alternate Answers ALL answer the question factually. Do not
include synonyms of the Answer as Alternate Answers that are incongruent with
the Question.
Word Count and Length Rules:
- Question Length: The Question statement length must be under 25 words, 1 -
2 sentences.
Core Inputs
--------
Question: {{ question }}
Answer: {{ correctAnswer }}
Learning Content: {{ learningContent }

### Explanation

The prompt generator 122 within the study mode delivery system 116 generates a refinement prompt to guide the AI engine to refine the initially generated FITB question, answer, and the learning content. The prompt provides the initially generated FITB question, answer, and learning content to the AI engine. The prompt also guides the AI engine to generate additional answers. The additional answers include synonyms, rewording of the answers, and small grammatical errors.

The LLM 126 is applied to refine the initially generated FITB question 106 by aligning with the educational standard and verifying the correctness of the corresponding answer and learning content. The AI engine 124 refines the generated content and the LLM 126 refines the generated question, answers, and the learning content. The LLM 126 provides relevant context for the AI engine 124 to generate the FITB question 106 of high quality.

The LLM 126 also processes variation in answers. For instance, a user uses synonyms for the generated FITB question 106 or might make a spelling error while answering the question correctly. The refinement prompt guides the AI engine 124 and utilizes the LLM 126 to take variations in the answer and mark them correctly. The synonyms are acceptable only when they fit into the blank seamlessly.

The prompt generator then utilizes the refinement prompt to guide the AI engine 124 to generate precise fill-in-the-blank question along with the answers and the learning content based on the generated FITB question 106 and refine the answers and learning content accordingly.

The AI engine 124 is then utilized to generate a final FITB question 106 and learning content 108 which is then displayed to the user on the study mode 104 of the online learning platform 102. In one of the embodiments, a curl command is utilized to instruct a function calling via tools and tool fields. The command is used to refine the FITB question 106 using the function which is given below for use with an OpenAI Chat Completions API:

```
[
    {
      “type”:“function”,
      “function”:{
        “name”:“get_FITB_revised”,
        “description”:“Get a revised Fill-in-the-Blank Question”,
        “parameters”:{
          “type”:“object”,
          “properties”: {
            “question”: {
              “type”: “string”,
              “description”:“The Revised Fill-in-the-Blank
Question”
            },
            “answer”: {
              “type”: “string”,
              “description”:“The Revised Answer to the Fill-in-
the-Blank Question”
            },
            “alternate_answers”: {
              “type”: “array”,
              “items”: {
                “type”: “string”
              },
              “description”:“Alternate Answers to the Fill-in-
the-Blank Question”
            }
          },
          “required”: [
            “question”,
            “answer”,
            “alternate_answers”
          ]
        }
      }
    }
  ]
```

### Explanation:

The refinement prompt generated by the prompt generator 122 guides the AI engine 124 to generate a revised FITB question 106, answer and learning content 108.

The AI engine 124 generates a final FITB question 106 along with the learning content 108, answer which is then displayed on the online learning platform 102. The final output is mentioned below:

```
{
  “question”: “Certain proteins produced as part of an organism's immune
response, called <blank>, identify and neutralize harmful
substances such as
microbes and toxins to enhance survival and reproduction.”,
  “answer”: “antibodies”
}
```

The user answers the generated FITB question 106 and the grader prompt guides the AI engine 124 to check the response of the user. If the user answers the question incorrectly the word in the blank will turn red and if the user answers the question correctly the word turns green.

An exemplary prompt constrains and guides the AI Engine 124 to grade the response of the user is given below:

Context
--------
You are a highly astute grader. You will be given a Fill-in-the-Blank
Question containing a ‘<blank>’, the Fill-in-the-Blank Answer, which is
intended to uniquely fill the ‘<blank>’, and a User Response. Your job is to
judge whether or not the User Response correctly fills in the ‘<blank>’.
Task
--------
1. Using the Fill-in-the-Blank Question and Fill-in-the-Blank Answer, follow
the Grading Guidelines to determine if the User Response accurately fills in
the ‘<blank>’ from the Fill-in-the-Blank Question.
2. Return this determination in the format specified in Output Format.
Grading Guidelines
--------
* Be lenient towards minor spelling errors.
* Synonyms to the Fill-in-the-Blank Answer are acceptable ONLY when they fit
seamlessly into the Fill-in-the-Blank Question.
* If the Fill-in-the-Blank Answer is a proper noun, only other synonomous
proper nouns are acceptable
Output Format
------------
Format your output as ONLY the word “CORRECT” or the word “INCORRECT” without
the quotation marks. The output should not contain the word ″output″ or
″classification.″
Core Inputs
------------
Fill-in-the-Blank Question: {{ question }}
Fill-in-the-Blank Answer: {{ correctAnswer }}
User Response: {{ studentAnswer }}

### Explanation:

The grading prompt guides the AI engine 124 to check the response of the user. The prompt guides the AI engine to accept minor spelling errors and synonyms. The answer is displayed to the user on the online learning platform 102 where the user can access the learning content 108 to further learn about the concept.

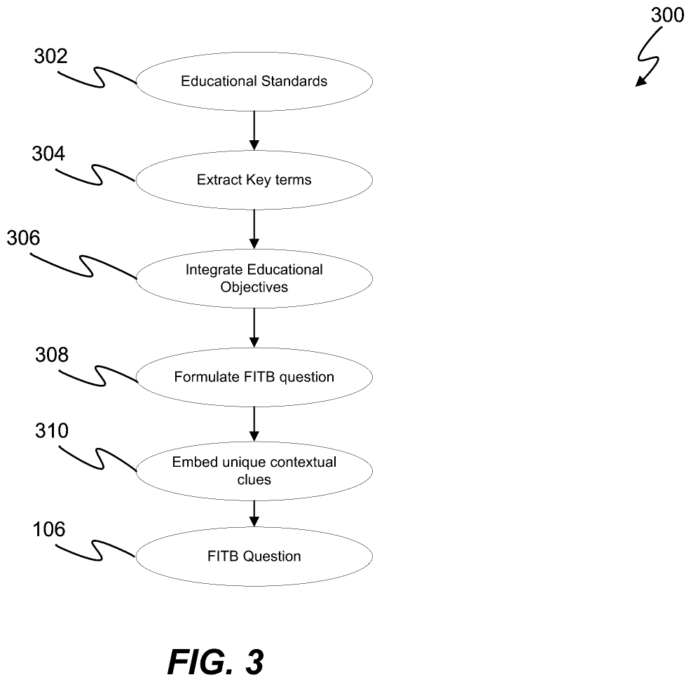

FIG. 3 depicts a flowchart 300 showing the steps to generate the FITB question 106.

Flowchart 300 depicts the steps involved in the generation of the FITB question 106. Initially, the study mode delivery system 116 fetches the educational standards 302 from the educational standards database 112. The analyzer 118 integrated within the study mode delivery system 116 then extracts key terms 304 related to the educational standards and integrates educational objectives 306. The core prompt utilizes the key terms to guide the AI engine 124 to formulate FITB question 306. The refinement prompt refines the formulated FITB question and embeds unique contextual clues 310 within the question itself. The AI engine 124 generates the FITB question 106 which is then displayed to the user on the online learning platform 102.

Below represents the pseudocode to generate a FITB question:

```
function createFITBQuestion(standards, keyTerms, objectives):
  extractedTerms = extractKeyTerms(standards)
  integratedObjective = integrateObjectives(extractedTerms,
objectives)
  question = formulateQuestion(integratedObjective)
  finalQuestion = embedIdentifiers(question)
  return finalQuestion
```

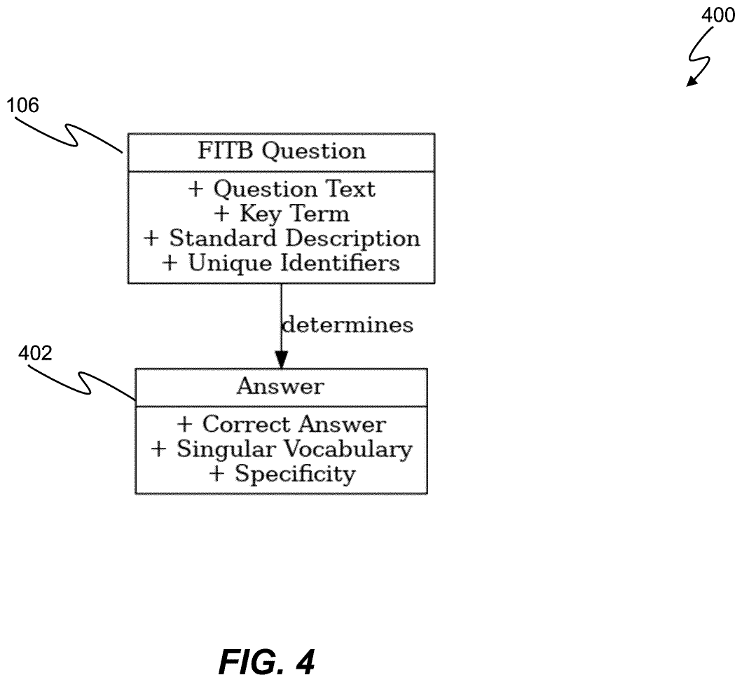

FIG. 4 represents a data structure 400 that stored information used to craft a FITB question 106 based on educational standards and key terms of the relevant educational curriculum.

The data structure 400 includes a plurality of components to craft a FITB question 106. The first node of the data structure 400 includes a FITB question 106. The FITB question 106 includes the question text, key terms, standard description, and unique identifiers. The question text is used for the generation of the FITB question. The key terms are pieces of vocabulary explaining key concepts related to a particular standard in the educational curriculum. The educational standard includes the standard for which the question will be generated.

The parameters of the question will determine the answer 402. The answer includes a correct answer, singular vocabulary, and specificity. Based on the question, the answer 402 will be determined. The LLM is used to refine the FITB question 106 and determine the answer 402. The LLM 126 identifies what the correct answer will be based on the generated question of that particular standard.

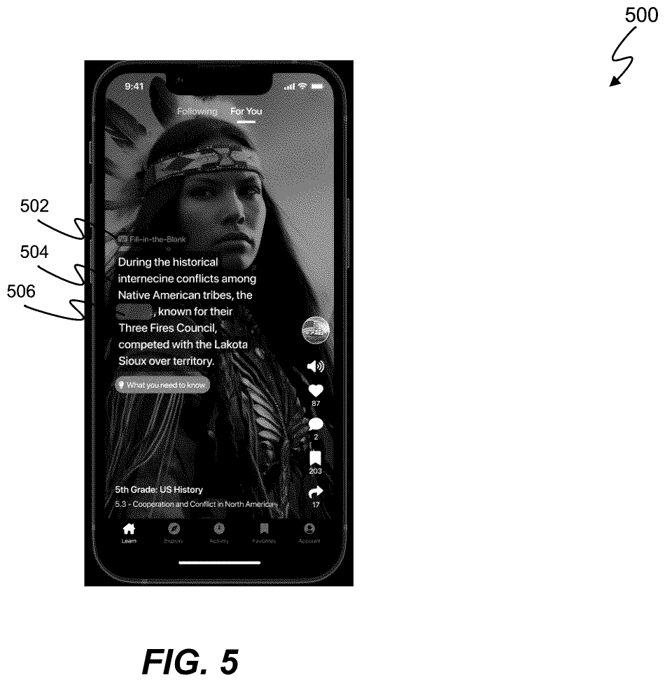

FIG. 5 depicts an exemplary user interface 500 disclosing the AI-generated FITB question 504 and learning content 108 presented to the user on the study mode 104 of the online learning platform 102.

The user interface 500 displays a FITB question 504 and the learning content 108 on the study mode 104 of the online learning platform 102. The fill-in-the-blank 502 is always present on the screen and is non-interactable. The user interface 500 presents a FITB question 504 about “the conflicts among the native American tribes”. The answer field 506 represents the blank/missing word that the user needs to answer. The FITB question 504 presents contextual clues for the user to answer the question.

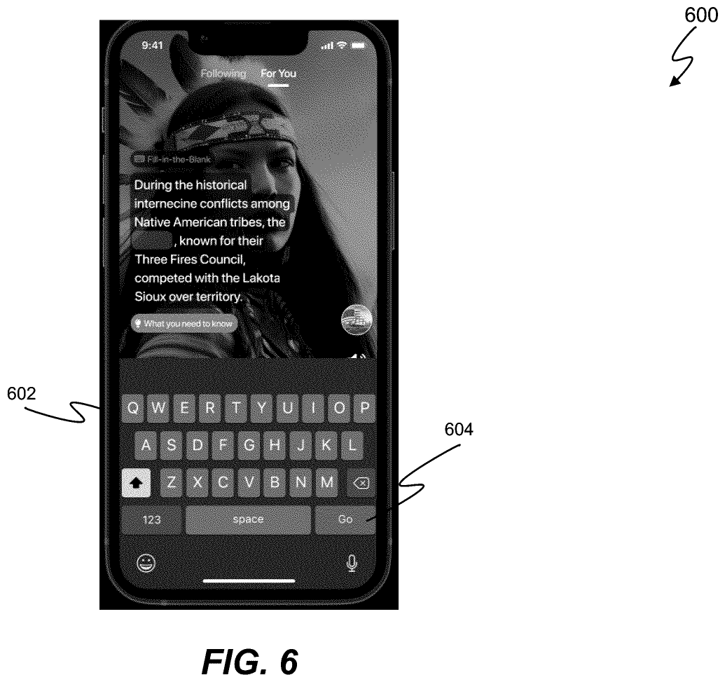

FIG. 6 depicts an exemplary user interface 600 disclosing the user's attempt to answer a FITB question 504 presented on the study mode 104 of the online learning platform 102.

The user interface 600 displays the user's attempt to answer the FITB question 504. As the user taps on the answer field 506, the “content-type”, title, and “what you need to know” move a bit upward on the screen and a standard on-screen keyboard 602 appears at the bottom of the user interface 600.

The user types the answer as the on-screen keyboard appears on the user interface 600 of the online learning platform 102. The student types the characters with the help of the on-screen keyboard 602. As the user types the answer he/she can press go/enter 604 on the on-screen keyboard 602 to trigger the response check.

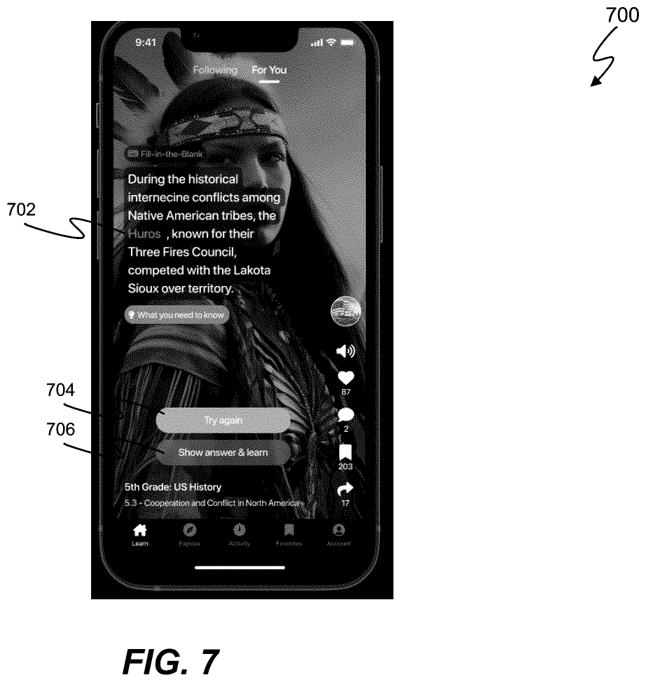

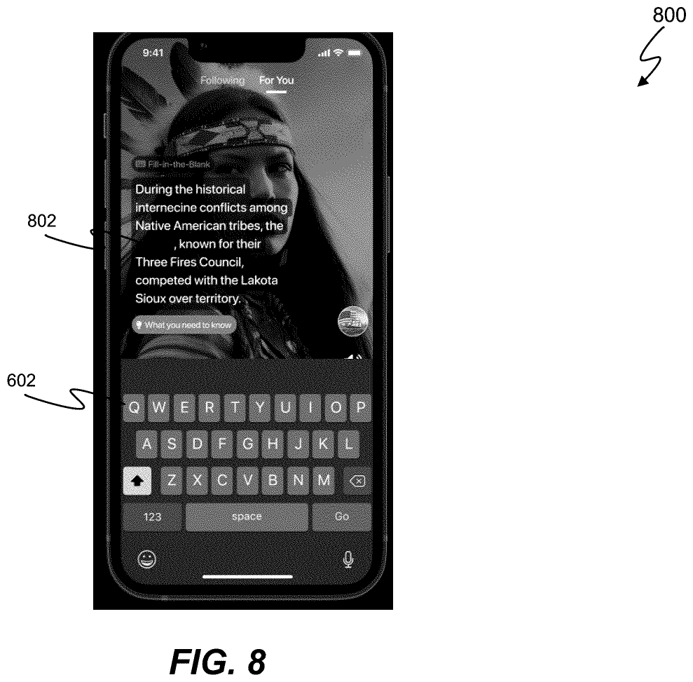

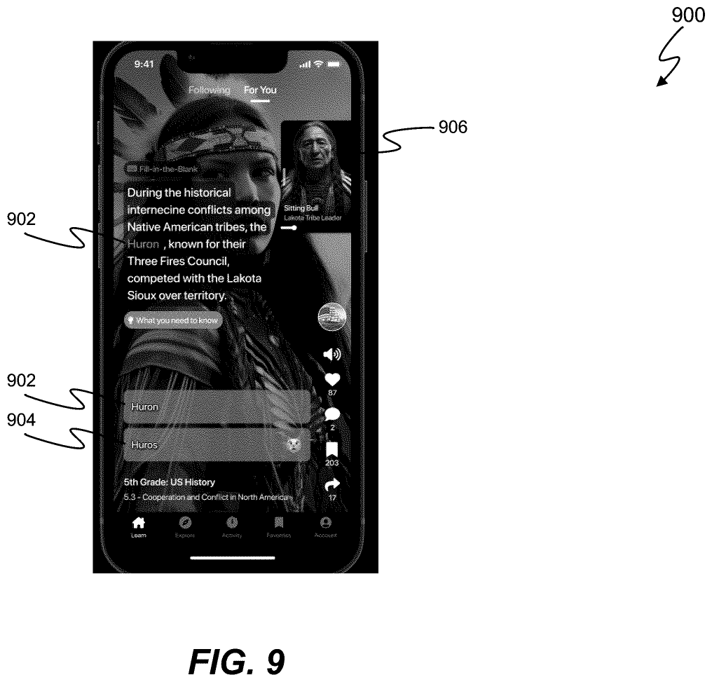

FIGS. 7-9 depict exemplary user interfaces displaying the incorrect response of the user and interaction with the AI-generated learning content.

The user interface 700 displays that the user has given an incorrect answer 702 to the FITB question 504. The submitted answer for the blank appears red if the user answers the blank incorrectly. As the user answers the question incorrectly, pop-up tabs are displayed. The pop-up tabs include a “try again” 704 tab, and a “show answer and learn” 706 tab.

The user interface 800 displays that the user clicks on the try again 704 tab when the user answers the blank incorrectly. When the user presses the try again 704 tab, the incorrect answer within the blank is replaced by a blank space 802 such that the user can now answer the FITB question 504. The on-screen keyboard reappears 602 and the user can re-attempt the question. If the user again submits an incorrect response, the pop-up tabs are again displayed to the user on study mode 104 of the online learning platform 102.

The user interface 900 displays that the user clicks on the “show answer and learn” 706 tab when the user answers the blank incorrectly. As the user presses on “show answer and learn” 806 tab, the correct answer 902 replaces the blank and appears green in color indicating the correct answer 902 for the generated FITB question 5604. The user interface 900 also displays the correct answer 902 and the incorrect answer 904 to highlight the difference between the submitted responses.

The learning content video 906 slides in from the right and starts playing the content which is described in the FITB question 504 as the correct answer 902 is displayed on the user interface 900. The AI-generated learning content video provides the context to explain the fact of the FITB question 504.

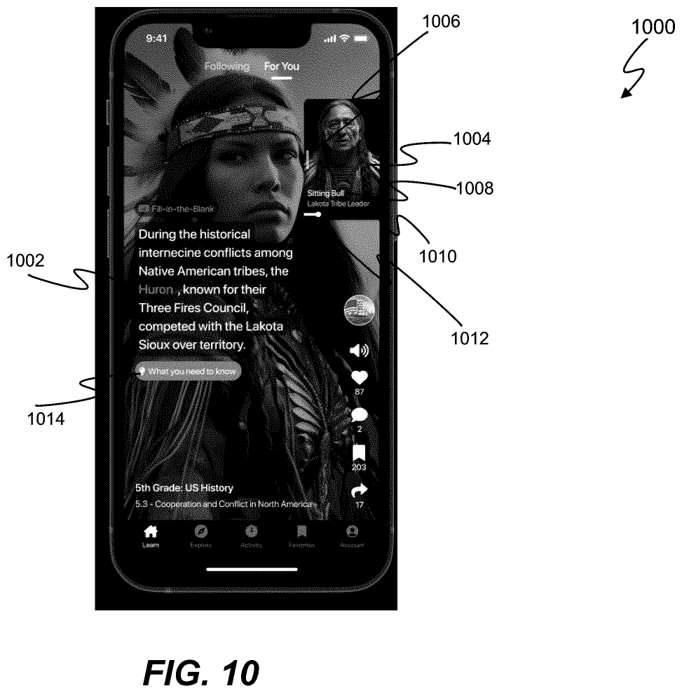

FIG. 10 depicts an exemplary user interface 1000 if the user attempts the question correctly and interacts with the learning content 108.

The user interface 1000 displays the correct response 1002 given by the user. The response turns green in color if the user answers the question correctly. As the user answers the question correctly, learning content video 1004 slides in and provides context to explain the facts of the FITB question 504. The user can click on the dismiss bar 1006 and dismiss the video at any time by swiping right on the video or by clicking on the dismiss bar 1006 on the left side of the video's window. The learning content 108 also presents the name of the figure “Sitting Bull” 1008 and the bio of the figure “Lakota Tribe Leader” 1010 which is sourced from the historical database based 114 on the FITB question 604 which is generated.

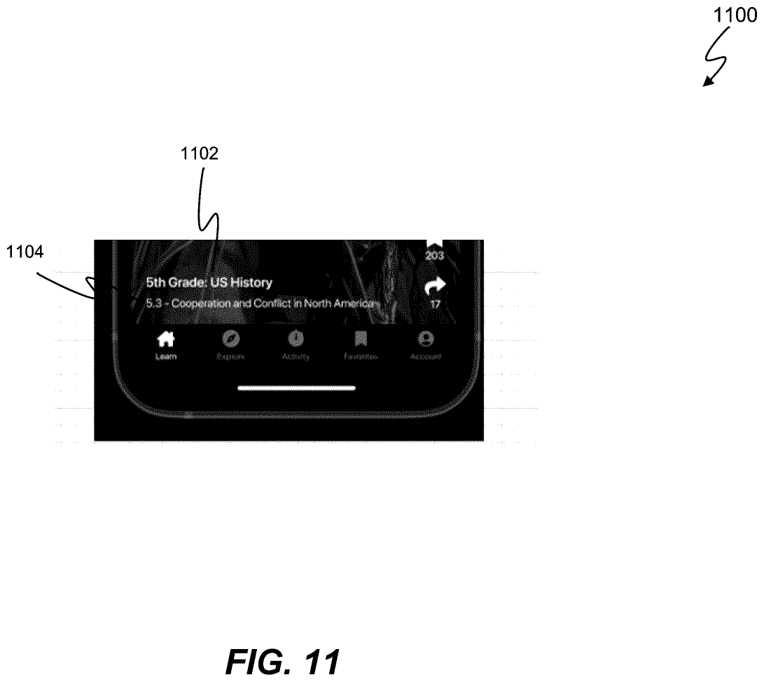

FIG. 11 depicts an exemplary user interface 1100 accessing information from the educational standards database to present the title and description of the AI-generated FITB question 504 presented to the user on the study mode 104 of the online learning platform 102.

The user interface 1100 describes the title 1102 “5th grade: US history” and the description 1104 “cooperation and conflict in North America”. The title 1102 depicts the name of the course to which the FITB question 504 belongs. The description 1104 depicts the domain id and description and cluster description accessed from the educational standard database 112.

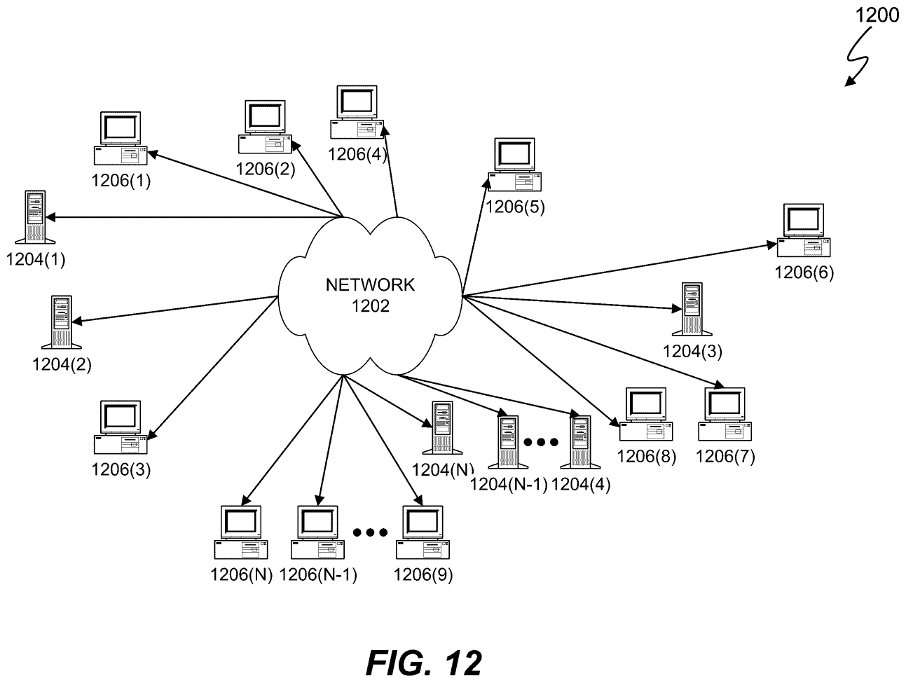

FIG. 12 is a block diagram illustrating a network environment in which a fill-in-the-blank (FITB) generation environment 100 and fill-in-the-blank (FITB) generation process 200 may be practiced. Network 1202 (e.g. a private wide area network (WAN) or the Internet) includes a number of networked server computer systems 1204(1)-(N) that are accessible by client computer systems 1206(1)-(N), where N is the number of server computer systems connected to the network. Communication between client computer systems 1206(1)-(N) and server computer systems 1204(1)-(N) typically occurs over a network, such as a public switched telephone network over asynchronous digital subscriber line (ADSL) telephone lines or high-bandwidth trunks, for example communications channels providing T1 or OC3 service. Client computer systems 1206(1)-(N) typically access server computer systems 1204(1)-(N) through a service provider, such as an internet service provider (“ISP”) by executing application specific software, commonly referred to as a browser, on one of client computer systems 1206(1)-(N).

Client computer systems 1206(1)-(N) and/or server computer systems 1204(1)-(N) are specialized computer programmed to improve conventional computer systems to implement and utilize the fill-in-the-blank (FITB) generation environment 100 and fill-in-the-blank (FITB) generation process 200. The type of computer system that can be specially programmed to implement and utilize the fill-in-the-blank (FITB) generation environment 100 and fill-in-the-blank (FITB) generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the fill-in-the-blank (FITB) generation environment 100 and fill-in-the-blank (FITB) generation process 200 can be implemented using code stored in a tangible, non-transient computer readable medium and executed by one or more processors. In at least one embodiment, the fill-in-the-blank (FITB) generation environment 100 and fill-in-the-blank (FITB) generation process 200 can be implemented completely in hardware using, for example, logic circuits and other circuits including field programmable gate arrays.

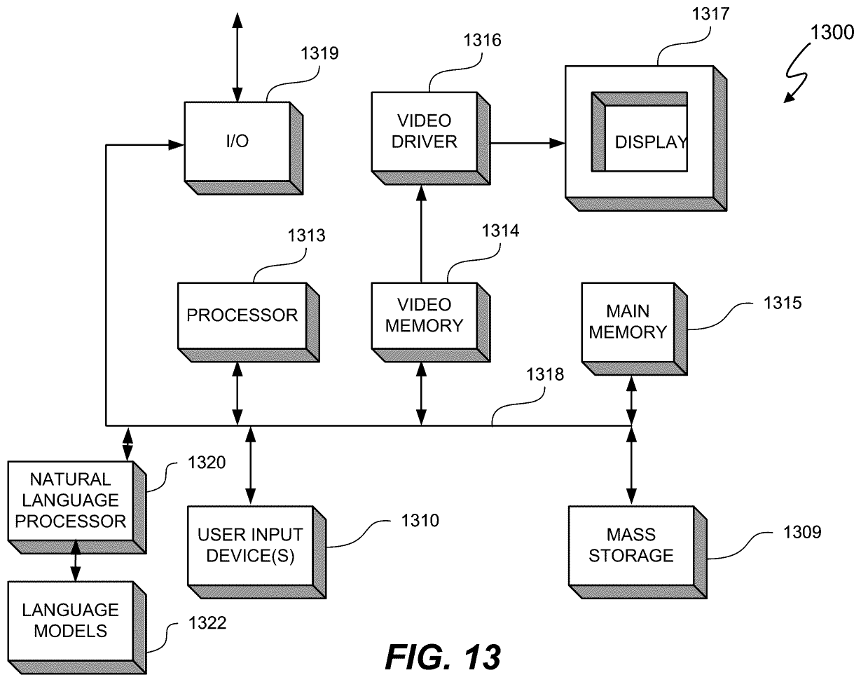

Embodiments of the fill-in-the-blank (FITB) generation environment 100 and fill-in-the-blank (FITB) generation process 200 can be implemented on a computer system such as a special-purpose, special-programmed computer 1300 illustrated in FIG. 13. Input user device(s) 1310, such as a keyboard and/or mouse, are coupled to a bi-directional system bus Y18. The input user device(s) 1310 are for introducing user input to the computer system and communicating that user input to processor 1313. The computer system of FIG. 13 generally also includes a non-transitory video memory 1314, non-transitory main memory 1315, and non-transitory mass storage 1309, all coupled to bi-directional system bus 1318 along with input user device(s) 1310 and processor 1313. The mass storage 1309 may include both fixed and removable media, such as a hard drive, one or more CDs or DVDs, solid state memory including flash memory, and other available mass storage technology. Bus 1318 may contain, for example, 32 of 64 address lines for addressing video memory 1314 or main memory 1315. The system bus 1318 also includes, for example, an n-bit data bus for transferring DATA between and among the components, such as CPU 1309, main memory 1315, video memory 1314 and mass storage 1309, where “n” is, for example, 32 or 64. Alternatively, multiplex data/address lines may be used instead of separate data and address lines.

I/O device(s) 1319 may provide connections to peripheral devices, such as a printer, and may also provide a direct connection to a remote server computer systems via a telephone link or to the Internet via an ISP. I/O device(s) 1319 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1309, into main memory 1315 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1313, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1315 is comprised of dynamic random access memory (DRAM). Video memory 1314 is a dual-ported video random access memory. One port of the video memory 1314 is coupled to video amplifier 1316. The video amplifier 1316 is used to drive the display 1317. Video amplifier 1316 is well known in the art and may be implemented by any suitable means. This circuitry converts pixel DATA stored in video memory 1314 to a raster signal suitable for use by display 1317. Display 1317 is a type of monitor suitable for displaying graphic images.

The computer system described above is for purposes of example only. The fill-in-the-blank (FITB) generation environment 100 and fill-in-the-blank (FITB) generation process 200 may be implemented in any type of computer system or programming or processing environment. It is contemplated that the fill-in-the-blank (FITB) generation environment 100 and fill-in-the-blank (FITB) generation process 200 might be run on a stand-alone computer system, such as the one described above. The fill-in-the-blank (FITB) generation environment 100 and fill-in-the-blank (FITB) generation process 200 might also be run from a server computer systems system that can be accessed by a plurality of client computer systems interconnected over an intranet network. Finally, the fill-in-the-blank (FITB) generation environment 100 and fill-in-the-blank (FITB) generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method that integrates programmatic control and a guided and constrained Artificial Intelligence (AI) engine to generate fill-in-the-blank (FITB) questions aligned with the educational curriculum for a user comprising:
executing code using one or more processors of a computer system to cause the computer system to perform operations comprising:
accessing an educational standards database and historical database by a study mode delivery system to retrieve relevant educational content;
receiving a standard description and a set of key terms from the relevant educational content from a user profile, educational standards, and historical database accessed by the study mode delivery system;
utilizing a natural language processing (NLP) model by an analyzer to analyze the received educational content;
generating a prompt by a prompt generator to guide the AI engine to generate an initial FITB question, including a corresponding answer and learning content based on the standard description and the set of key terms;
transferring the prompt to the AI engine to generate the FITB question, along with the corresponding answer and learning content; and
guiding and constraining the AI engine using an engineered prompt to refine the initially generated FITB question to generate the final FITB question, along with the corresponding answer and learning content by aligning with the educational standard and learning content.

2. The method of claim 1 further comprising:
generating a grader assistant prompt for identifying the correctness of the user response on the refined generated FITB question; and
transferring the grader assistant prompt to the AI engine to check the correctness of the user response on the online learning platform.

3. The method of claim 1 wherein the generated FITB question embeds unique contextual clues, ensuring that the answer provided by the user is uniquely identifiable and correct based on the detailed context given in the FITB question.

4. The method of claim 1 further comprising:
developing learning content designed to align with the FITB question, wherein the learning content is structured to provide comprehensive knowledge necessary to answer the FITB question without directly hinting at the answer.

5. The method of claim 1 further comprising:
identifying if quality criteria of the generated initial FITB question is not met, then the AI engine is configured to regenerate the fill-in-the-blank question and learning content using the AI ENGINE.

6. The method of claim 1 wherein the quality criteria includes automated validation against a set of predefined checks such as relevance, clarity, difficulty level, and grammatical correctness.

7. The method of claim 1 wherein the AI ENGINE is trained using a dataset specifically curated for educational content to enhance the relevance and accuracy of the generated fill in the blank questions.

8. The method of claim 1 wherein the educational standards include Common Core State Standards (CCSS), Next Generation Science Standards (NGSS), and Advanced Placement (AP).

9. The method of claim 1 wherein storing the generated FITB questions and learning content in a data repository.

10. A system that integrates programmatic control and a guided and constrained Artificial Intelligence (AI) engine to generate fill-in-the-blank (FITB) questions aligned with the educational curriculum for a user comprising:
one or more processors of a computer system; and
a memory, coupled to the one or more processors, storing code that when executed causes the computer system to perform operations comprising:
accessing an educational standards database and historical database by a study mode delivery system to retrieve relevant educational content;
receiving a standard description and a set of key terms from the relevant educational content from a user profile accessed by the study mode delivery system;
utilizing a natural language processing (NLP) model by an analyzer to analyze the received educational content;
generating a prompt by a prompt generator to guide the AI engine to generate an initial FITB question, including a corresponding answer and learning content based on the standard description and the set of key terms;
transferring the prompt to the AI engine to generate the FITB question, along with the corresponding answer and learning content; and
guiding and constraining an AI engine using an engineered prompt to refine the initially generated FITB question to generate the final FITB question, along with the corresponding answer and learning content by aligning with the educational standard and learning content.

11. The system of claim 9 wherein the generated FITB question embeds unique contextual clues, ensuring that the answer provided by the user is uniquely identifiable and correct based on the detailed context given in the FITB question.

12. The system of claim 9 wherein the memory stores code that when executed causes the computer system to further perform operations comprising:
developing learning content designed to align with the FITB question, wherein the learning content is structured to provide comprehensive knowledge necessary to answer the FITB question without directly hinting at the answer.

13. The system of claim 9 wherein the memory stores code that when executed causes the computer system to further perform operations comprising:
identifying if the quality criteria of the generated initial FITB question is not met, then the AI engine is configured to regenerate the fill-in-the-blank question and learning content using the AI ENGINE.

14. The system of claim 9 wherein the quality criteria includes automated validation against a set of predefined checks such as relevance, clarity, difficulty level, and grammatical correctness.

15. The system of claim 9 wherein the AI ENGINE is trained using a dataset specifically curated for educational content to enhance the relevance and accuracy of the generated FITB questions.

16. The system of claim 9 wherein the educational standards include Common Core State Standards (CCSS), Next Generation Science Standards (NGSS), and Advanced Placement (AP).

17. The system of claim 9 wherein storing the generated FITB questions and learning content in a data repository.
